(19) United States
(12) Patent Application Publication
(10) Pub. No.: US 2013/0244097 A1
(43) Pub. Date: Sep. 19, 2013

(54) COMPOSITE MATERIALS, PRODUCTION THEREOF AND USE THEREOF IN ELECTROCHEMICAL CELLS

(71) Applicant: BASF SE, Ludwigshafen (DE)

(72) Inventors: Klaus LEITNER, Ludwigshafen (DE); Alexander Panchenko, Ludwigshafen (DE); Oliver Gronwald, Frankfurt (DE); Arnd Garsuch, Ludwigshafen (DE); Heino Sommer, Eggenstein-Leopoldshafen (DE); Norbert Bischof, Mannheim (DE); Andrea Krebs, Boehl-lggelheim (DE)

(73) Assignee: BASF SE, Ludwigshafen (DE)

(21) Appl. No.: 13/794,971

(22) Filed: Mar. 12, 2013

Related U.S. Application Data
(60) Provisional application No. 61/610,500, filed on Mar. 14, 2012.

(51) Int. Cl. H01M 4/133

(52) U.S. Cl. CPC H01M 4/133
USPC 429/188; 252/511; 429/213

(57) ABSTRACT

A composite material suitable for an inexpensive cathode material for a lithium-sulfur cell. The composite material is obtained by thermally treating a mixture, wherein the mixture comprises: (A) a fluorinated polymer and (B) carbon in a polymorph containing at least 60% sp²-hybridized carbon atoms; or (A) a fluorinated polymer and (C) a sulfur-containing component; or (A) a fluorinated polymer, (B) carbon in a polymorph containing at least 60% sp²-hybridized carbon atoms, and (C) a sulfur-containing component, in which the proportion of the sum of the proportions by weight of starting components (A) and (B), (A) and (C), or (A), (B), and (C) in the respective mixture prior to the thermal treatment, based on the total weight of the mixture, is 90 to 100% by weight, and wherein the thermal treatment of the mixture containing the above starting components is performed at a temperature of at least 115° C.

The present invention relates to novel composite materials which have been produced using, as starting components, at least

(A) at least one fluorinated polymer,
(B) carbon in a polymorph comprising at least 60% sp²-hybridized carbon atoms, and
(C) at least one sulfur-containing component,
comprising a mixture which has been thermally treated in one process step and comprises starting components (A) and (B) or starting components (A) and (C) or starting components (A), (B) and (C), where the proportion of the sum of the proportions by weight of starting components (A) and (B), (A) and (C) or (A), (B) and (C) in the respective mixture prior to the thermal treatment, based on the total weight of the mixture prior to the thermal treatment, is 90 to 100% by weight, and where the thermal treatment of the mixture comprising starting components (A) and (B), (A) and (C) or (A), (B) and (C) is performed at a temperature of at least 115° C.

In addition, the present invention also relates to a process for producing inventive composite materials, to cathode materials for electrochemical cells comprising inventive composite materials, to corresponding electrochemical cells and to specific thermally treated mixtures comprising at least starting components (A) and (C).

Storing energy has long been a subject of growing interest. Electrochemical cells, for example batteries or accumulators, can serve for storage of electrical energy. Recently, what are called lithium ion batteries have been the subject of particular interest. They are superior to the conventional batteries in some technical aspects. For instance, they can be used to generate voltages which are not obtainable with batteries based on aqueous electrolytes.

However, the energy density of conventional lithium ion accumulators which have a carbon anode and a cathode based on metal oxides is limited. New dimensions with regard to energy density are being opened up by lithium-sulfur cells. In lithium-sulfur cells, sulfur is reduced in the sulfur cathode via polysulfide ions to S²⁻, which is oxidized again as the cell is charged to form sulfur-sulfur bonds. In the course of the charging and discharging operations, the structure of the cathode accordingly changes, which corresponds at the macroscopic level to expansion and shrinkage, i.e. a change in the volume, of the cathode.

As well as the sulfur, the cathode in a lithium-sulfur cell typically also comprises carbon black or carbon black mixtures, and binders.

The binders typically present in the cathodes of lithium-sulfur cells serve firstly to contact the carbon black particles, which are electrically conductive, with the electrochemically active sulfur, which is not itself electrically conductive, and secondly for connection of the sulfur-carbon black mixture to the output materials of the cathode, for example metal foils, metal meshes or metal-coated polymer films. Possible binders, which are typically organic polymers, and the chemical and physical properties of the binders are known in principle to those skilled in the art.

CN 101453009 describes the use of polylactic acid as a binder in cathodes for lithium-sulfur cells.

KR 2005087977 describes the use of carboxymethylcellulose (CMC) as a binder in cathode materials which are used for construction of lithium-sulfur batteries.

US 2004/0009397 describes various fluorinated or partly fluorinated polymers or copolymers, particularly together with styrene-butadiene rubbers, as binders in cathode materials for lithium-sulfur batteries.

In US 2010/0239914, polyvinyl alcohol is used as a binder for production of cathodes for lithium-sulfur cells.

WO 2011/148357 describes sulfur-containing composite materials for cathodes, which are obtained by thermal conversion of polyacrylonitrile, sulfur and carbon black.

J. Power Sources 205 (2012) 420-425 studies the influence of various cathode materials and binders on the function of lithium-sulfur batteries.

The sulfur-containing cathode materials described in the literature still have shortcomings with regard to one or more of the properties desired for cathode materials and the electrochemical cells produced therefrom. Desirable properties are, for example, good adhesion capacity of the cathode materials to the output materials, high electrical conductivity of the cathode materials, a rise in the cathode capacity, an increase in the lifetime of the electrochemical cell, an improvement in the chemical stability of the cathode or a reduced change in volume of the cathodes during a charge-discharge cycle. In general, the desired properties mentioned also make a crucial contribution to improving the economic viability of the electrochemical cell, which, as well as the aspect of the desired technical performance profile of an electrochemical cell, is of crucial significance to the user.

It was thus an object of the present invention to provide an inexpensive cathode material for a lithium-sulfur cell, which has advantages over one or more properties of a known cathode material, more particularly a cathode material which enables the construction of cathodes with an improved electrical conductivity, combined with high cathode capacity, high mechanical stability and long lifetime.

This object is achieved by a composite material which has been produced using, as starting components, at least

(A) at least one fluorinated polymer,
(B) carbon in a polymorph comprising at least 60% sp²-hybridized carbon atoms, and
(C) at least one sulfur-containing component,
comprising a mixture which has been thermally treated in one process step and comprises starting components (A) and (B) or starting components (A) and (C) or starting components (A), (B) and (C), where the proportion of the sum of the proportions by weight of starting components (A) and (B), (A) and (C) or (A), (B) and (C) in the respective mixture prior to the thermal treatment, based on the total weight of the mixture prior to the thermal treatment, is 90 to 100% by weight, and where the thermal treatment of the mixture comprising starting components (A) and (B), (A) and (C) or (A), (B) and (C) is performed at a temperature of at least 115° C.

Composite materials are generally understood to mean materials which are solid mixtures which cannot be separated manually and which have different properties than the individual components. The inventive composite materials are specifically particulate composite materials.

The production of the inventive composite material uses, as starting components, at least one component (A), which is at least one fluorinated polymer, also called polymer (A) hereinafter for short, at least one component (B), which is carbon in a polymorph comprising at least 60% sp²-hybridized carbon atoms, also called carbon (B) hereinafter for short, and at least one component (C), which is at least one sulfur-containing component, also called component (C) hereinafter for short. The inventive composite material comprises a thermally treated mixture comprising starting components (A) and (B) or starting components (A) and (C) or starting components (A), (B) and (C), especially starting components (A), (B) and (C), where the proportion of the sum of the proportions by weight of starting components (A) and (B), (A) and (C) or (A), (B) and (C), especially (A), (B) and (C), in the respective mixture prior to the thermal treatment, based on the total weight of the mixture prior to the thermal treatment, is 90 to 100% by weight, especially 95 to 100% by weight.

Polymer (A), i.e. starting component (A), is at least one fluorinated polymer, the person skilled in the art being aware of numerous representatives of this polymer class. Polymer (A) may thus also be a mixture of two or more fluorinated polymers. Polymer (A) is preferably one fluorinated polymer. The fluorinated polymers may be perfluorinated or partly fluorinated polymers, or else fluorinated homo- or copolymers. Preference is given to selecting polymer (A) from the group of fluorinated polymers consisting of polytetrafluoroethylene, polyvinyl fluoride, polyvinylidene fluoride, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Preference is given to using polymer (A) in powder form. Particular preference is given to using a powder with an average particle size of 0.1 to 10 μm, especially 0.5 to 2 μm.

Polytetrafluoroethylene is understood in the context of the present invention to mean not only polytetrafluoroethylene homopolymers but also copolymers of tetrafluoroethylene with hexafluoropropylene or vinylidene fluoride, and terpolymers consisting of tetrafluoroethylene, hexafluoropropylene and vinylidene fluoride.

Polymer (A) is preferably polytetrafluoroethylene, especially polytetrafluoroethylene homopolymer.

In one embodiment of the present invention, a feature of the inventive composite material is that the fluorinated polymer is polytetrafluoroethylene, especially polytetrafluoroethylene homopolymer.

Carbon in a polymorph comprising at least 60% sp²-hybridized carbon atoms, preferably from 75% to 100% sp²-hybridized carbon atoms, also called carbon (B) for short in the context of the present invention, is known as such. The carbon (B) is an electrically conductive polymorph of carbon. Carbon (B) may be selected, for example, from graphite, carbon black, activated carbon, carbon nanotubes, carbon nanofibers, graphene or mixtures of at least two of the aforementioned substances.

Figures in % by weight are based on all of the carbon (B) which is used in the production of the inventive composite material, including any impurities, and mean percent by weight.

In one embodiment of the present invention, carbon (B) is carbon black. Carbon black may be selected, for example, from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one embodiment of the present invention, a feature of the inventive composite material is that carbon (B) is selected from carbon black.

In one variant, carbon (B) is partially oxidized carbon black.

In one embodiment of the present invention, carbon (B) comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al. in Chemie Ingenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes can be produced by processes known per se. For example, it is possible to decompose a volatile carbon compound, for example methane or carbon monoxide, acetylene or ethylene, or a mixture of volatile carbon compounds, for example synthesis gas, in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon compounds in a light arc, in the presence or absence of a decomposition catalyst.

In one embodiment, the decomposition of volatile carbon compounds or of carbon compounds is performed in the presence of a decomposition catalyst, for example Fe, Co or preferably Ni.

In a further embodiment of the present invention, carbon (B) comprises carbon nanofibers, especially conductive graphitized carbon nanofibers, which have a diameter in the range from 50 to 300 nm, preferably 70 to 200 nm, and a length in the range from 1 μm to 100 μm, preferably 2 μm to 30 μm. Carbon nanofibers are commercially available, for example from carbon NT&F 21®.

In the context of the present invention, graphene is understood to mean almost ideally or ideally two-dimensional hexagonal carbon crystals of analogous structure to single graphite layers.

Carbon (B) may, for example, be in the form of particles having a diameter in the range from 0.1 to 100 μm, preferably 2 to 20 μm. The particle diameter is understood to mean the mean diameter of the secondary particles, determined as the volume average. The particle size distribution was determined by means of laser diffraction technology in powder form with a Mastersizer from Malvern Instruments GmbH, Herrenberg, Germany.

In one embodiment of the present invention, carbon (B) and especially carbon black has a BET surface area in the range from 20 to 1500 m²/g, measured to ISO 9277.

In one embodiment of the present invention, at least two, for example two or three, different kinds of carbon (B) are mixed. Different kinds of carbon (B) may differ, for example, with regard to particle diameter or BET surface area or extent of contamination.

In one embodiment of the present invention, the carbon (B) selected is a combination of two different carbon blacks, more particularly a combination of two different carbon blacks and carbon nanofibers.

In addition, in the production of the inventive composite material, component (C) used is at least one sulfur-containing component. Sulfur-containing components comprise sulfur in elemental form or bound in a chemical compound comprising at least one sulfur atom. The sulfur-containing component is preferably selected from the group consisting of elemental sulfur, a composite produced from elemental sulfur and at least one polymer, a polymer comprising divalent di- or polysulfide bridges and mixtures thereof. More particularly, the sulfur-containing component is elemental sulfur.

Elemental sulfur is known as such.

Composites produced from elemental sulfur and at least one polymer, which find use as a constituent of electrode materials, are likewise known to those skilled in the art. Adv. Funct. Mater. 2003, 13, 487 ff. describes, for example, a reaction product of sulfur and polyacrylonitrile, which forms through elimination of hydrogen from polyacrylonitrile with simultaneous hydrogen sulfide formation.

Polymers comprising divalent di- or polysulfide bridges, for example polyethylene tetrasulfide, are likewise known in principle to those skilled in the art. J. Electrochem. Soc., 1991, 138, 1896-1901 and U.S. Pat. No. 5,162,175 describe the replacement of pure sulfur with polymers comprising disulfide bridges. Polyorganodisulfides are used therein as materials for solid redox polymerization electrodes in rechargeable cells together with polymeric electrolytes.

In one embodiment of the present invention, a feature of the inventive composite material is that the sulfur-containing component is elemental sulfur.

The inventive composite material comprises a mixture which has been thermally treated in one process step and which comprises starting components (A) and (B) or starting components (A) and (C) or starting components (A), (B) and (C). Component (A) serves particularly to mechanically bind the further components (B) and/or (C) to one another, i.e. component (A) serves for mechanical stabilization of the inventive composite material.

The proportion by weight of starting component (A) in the respective mixture prior to the thermal treatment, based on the total weight of the mixture prior to the thermal treatment, can in principle be varied within a wide range. Preferably, the proportion by weight of component (A) in the mixture prior to the thermal treatment is in the range from 1 to 20% by weight, more preferably in the range from 3 to 15% by weight, especially in the range from 4 to 11% by weight.

In one embodiment of the present invention, a feature of the inventive composite material is that the proportion by weight of starting component (A) in the respective mixture prior to the thermal treatment, based on the total weight of the mixture prior to the thermal treatment is 4 to 11% by weight.

In a further preferred embodiment, the proportion by weight of component (B) in the inventive composite material is preferably in the range from 1 to 60% by weight, more preferably in the range from 5 to 50% by weight, based on the total mass of the composite material. The proportion of component (B) is calculated from the amount of this component used, based on the total mass of the composite material.

The process step in which the mixture comprising starting components (A) and (B) or starting components (A) and (C) or starting components (A), (B) and (C), especially starting components (A), (B) and (C), is treated thermally binds the components in the inventive composite material and improves the conductivity and the mechanical and electrochemical stability of the composite material overall.

In order to ensure a homogeneous distribution of the starting components in the thermally treated mixture, in the course of formulation of the mixture from the starting components, these are preferably mixed homogeneously with one another by appropriate mixing processes.

In one embodiment of the present invention, the inventive composite material has the feature that, prior to the process step of thermal treatment of the mixture, starting components (A) and (B), (A) and (C) or (A), (B) and (C), especially (A), (B) and (C), are present in homogeneous distribution in this mixture.

The thermal treatment, which is performed at a temperature of at least 115° C., preferably does not noticeably alter the chemical nature of the starting materials used, if at all. In principle, the thermal treatment of the mixture comprising starting components (A) and (B), (A) and (C) or (A), (B) and (C), especially (A), (B) and (C), can be performed within a wide temperature range starting from at least 115° C., provided that no noticeable chemical reactions occur. Preference is given to performing the thermal treatment of the mixture at a temperature in the range from 120 to 500° C., more preferably from 150 to 400° C., especially from 250 to 380° C.

In one embodiment of the present invention, the inventive composite material has the feature that the thermal treatment of the mixture comprising starting components (A) and (B), (A) and (C) or (A), (B) and (C), especially (A), (B) and (C), takes place at a temperature in the range from 250 to 380° C.

In the presence of elemental sulfur as component (C), the thermal treatment is preferably performed in a closed vessel in which a pressure can build up, for example in an autoclave. In this way, unhindered escape of elemental sulfur from the mixture at temperatures of at least 115° C. is prevented.

No noticeable chemical reactions, if any, during the thermal treatment step can be observed particularly in the case of those mixtures of starting components (A) and (B), (A) and (C) or (A), (B) and (C) which have a hydrogen content of less than 2% by weight, more preferably less than 1.0% by weight, especially less than 0.5% by weight, determined by means of elemental analysis. It is known that elemental sulfur reacts thermally with hydrocarbons, for example paraffins, with elimination of hydrogen sulfide.

In one embodiment of the present invention, the inventive composite material has the feature that, prior to the process step of thermal treatment of the mixture, said mixture of starting components (A) and (B), (A) and (C) or (A), (B) and (C) has a hydrogen content of less than 0.5% by weight, determined by means of elemental analysis.

The above-described inventive composite material is more preferably produced from the starting materials of polytetrafluoroethylene as component (A), carbon (B), which preferably has a carbon content of more than 95% by weight, based on the total amount of carbon (B), and elemental sulfur as component (C), where the sum of the three starting components (A), (B) and (C) together is at least 95% by weight, preferably between 98 and 100% by weight, based on the total weight of the composite material. In the inventive composite material, the sum of the contents of the elements carbon, sulfur and fluorine, determined by means of elemental analysis, is accordingly preferably at least 95% by weight, especially at least 97% by weight up to 100% by weight.

In one embodiment of the present invention, the inventive composite material has the feature that the sum of the contents of the elements carbon, sulfur and fluorine in the composite material, determined by means of elemental analysis, is at least 95% by weight.

In a preferred embodiment of the present invention, the inventive composite material has a sulfur content in the range from 20 to 80% by weight, preferably 37 to 70% by weight, which is determined by elemental analysis.

The above-described inventive composite material can be produced in different ways. A process for producing the inventive composite material as already described above preferably in each case comprises a process step in which a mixture comprising starting components (A) and (B), (A) and (C) or (A), (B) and (C), especially (A), (B) and (C), is treated thermally at a temperature of at least 115° C. The thermally treated mixture consists to an extent of 90 to 100% by weight of the corresponding starting components (A) and (B), (A) and (C) or (A), (B) and (C).

Any component (C) still absent is subsequently added to the thermally treated mixture and the composite material is completed by means of suitable homogenization methods, preference being given to using a further thermal treatment step.

The present invention further provides a process for producing a composite material, especially an inventive composite material as described above, comprising at least one process step wherein a mixture comprising starting components

(A) at least one fluorinated polymer and
(B) carbon in a polymorph comprising at least 60% sp²-hybridized carbon atoms,
or
(A) at least one fluorinated polymer and
(C) at least one sulfur-containing component,
or
(A) at least one fluorinated polymer,
(B) carbon in a polymorph comprising at least 60% sp²-hybridized carbon atoms, and
(C) at least one sulfur-containing component,
is treated thermally at a temperature of at least 115° C., where the proportion of the sum of the proportions by weight of starting components (A) and (B), (A) and (C) or (A), (B) and (C) in the respective mixture prior to the thermal treatment, based on the total weight of the mixture prior to the thermal treatment, is 90 to 100% by weight.

The description and preferred embodiments of components (A), (B) and (C) in the process according to the invention correspond to the above description of these components for the inventive composite material.

As described above, the thermal treatment of the mixture is preferably performed at a temperature in the range from 120 to 500° C., more preferably from 150 to 400° C., especially from 250 to 380° C.

In one embodiment of the present invention, the process according to the invention for production of a composite material has the feature that the thermal treatment of the mixture comprising starting components (A) and (B), (A) and (C) or (A), (B) and (C) takes place at a temperature in the range from 250 to 380° C.

The duration for the thermal treatment of the mixture can vary within a wide range and depends upon factors including the temperature at which thermal treatment is performed. The duration for the thermal treatment may be from 0.25 to 50 hours, preferably from 0.5 to 12 hours, especially from 1 to 5 hours.

More particularly, the process according to the invention is suitable for industrial production of composite materials in continuous and/or batchwise mode. In batchwise mode, this means batch sizes greater than 10 kg, better >100 kg, even more optimally >1000 kg or >5000 kg. In continuous mode, this means production volumes of more than 100 kg/day, better >1000 kg/day, even more optimally >10 t/day or >50 t/day.

The inventive composite materials obtained in the process according to the invention are typically comminuted further by subsequent comminution steps known to those skilled in the art to a pulverulent form, which can ultimately be used as an essential constituent of cathode materials for electrochemical cells, especially lithium-sulfur cells.

The present invention further also provides a cathode material for an electrochemical cell, comprising at least one inventive composite material as described above.

The inventive cathode material may in principle, as well as the inventive composite material, further comprise one or more binders, which are polymers, as described, for example, in WO 2011/148357, page 7 lines 5-25, and optionally further carbon (B) as described above. However, the inventive cathode material preferably comprises at least 95% by weight, especially between 97 and 100% by weight, of the inventive composite material. Output plates and supply lines are not included here.

Inventive composite materials and inventive cathode materials are particularly suitable as or for production of cathodes, especially for production of cathodes or lithium-containing batteries. The present invention provides for the use of inventive composite materials or inventive cathode materials as or for production of cathodes for electrochemical cells.

Inventive composite materials and inventive cathode materials additionally have the feature that rechargeable electrochemical cells are producible in accordance with the invention, which are stable preferably over a least 5 cycles, more preferably over at least 10 cycles, even more preferably over at least 50 cycles, especially over at least 100 cycles or over at least 150 cycles, more particularly while exhibiting a retention of the starting capacity of at least 80%.

In the context of the present invention, that electrode which has reducing action in the course of discharging (work) is referred to as the cathode.

In one embodiment of the present invention, inventive composite material or inventive cathode material is processed to cathodes, for example in the form of continuous belts which are processed by the battery manufacturer.

Cathodes produced from inventive composite material or inventive cathode material may have, for example, thicknesses in the range from 20 to 500 μm, preferably 40 to 200 μm. They may, for example, be in the form of rods, in the form of round, elliptical or square columns or in cuboidal form, or in the form of flat cathodes.

As well as the inventive electroactive composite material or the inventive cathode materials, the inventive cathode generally comprises electrical contacts for supply and withdrawal of charges, for example an output conductor, which may be configured in the form of a metal wire, metal grid, metal mesh, expanded metal, or of a metal foil or metal sheet. Suitable metal foils are especially aluminum foils.

The examples which follow are intended to illustrate basic routes for production of inventive composite material or for production of inventive cathodes:
1. Sulfur, carbon black and PTFE are mixed and then treated thermally at 350° C. for 1 to 5 hours. The composite material formed is used for the cathode preparation.
1a. A mixture of sulfur, carbon black and PTFE is applied as a layer to an aluminum foil and then treated thermally at 350° C. for 1 to 5 hours to obtain a finished electrode.
2. Carbon black and PTFE are mixed and then treated thermally at 350° C. for 1 to 5 hours. The thermally treated mixture is then mixed with sulfur and optionally treated thermally at 180° C. for 1 to 5 hours or used directly. The composite material is used for the cathode preparation.
2a. A mixture of carbon black and PTFE is applied as a layer to an aluminum foil and then treated thermally at 350° C. for 1 to 5 hours. Subsequently, sulfur is applied to the thermally treated layer (for example spraying or knife coating) and optionally treated thermally at 180° C. for 1 to 5 hours or used directly as a cathode.
3. Sulfur and PTFE are mixed and then treated thermally at 350° C. for 1 to 5 hours. The thermally treated mixture is then mixed with carbon black and treated thermally at 350° C. for 1 to 5 hours. The composite material formed is used for the cathode preparation.

Particular preference is given to processes based on examples 1 and 1a, and to the cathodes obtainable by these processes.

The present invention further provides electrochemical cells comprising at least one cathode which has been produced from or using at least one inventive composite material or at least one inventive cathode material. Preference is thus given to electrochemical cells comprising at least one cathode comprising inventive composite material.

In one embodiment of the present invention, inventive electrochemical cells comprise, as well as inventive composite material or inventive cathode material, at least one electrode comprising metallic magnesium, metallic aluminum, metallic zinc, metallic sodium or preferably metallic lithium.

In one embodiment of the present invention, the inventive electrochemical cell has the feature that it further comprises at least one electrode comprising metallic lithium.

The above-described inventive electrochemical cells comprise, as well as inventive composite material or inventive cathode material, a liquid electrolyte comprising a lithium-containing conductive salt.

In a further embodiment of the present invention, the inventive electrochemical cell has the feature that it comprises a liquid electrolyte comprising a lithium-containing conductive salt.

The above-described inventive electrochemical cells comprise, as well as inventive composite material or inventive cathode material, and preferably a further electrode, especially an electrode comprising metallic lithium, especially at least one nonaqueous solvent which may be solid or liquid at room temperature, preferably liquid at room temperature, and which is preferably selected from polymers, cyclic or noncyclic ethers, cyclic or noncyclic acetals, cyclic or noncyclic organic carbonates and ionic liquids.

In a further embodiment of the present invention, the inventive electrochemical cell has the feature that it comprises at least one nonaqueous solvent selected from polymers, cyclic or noncyclic ethers, noncyclic or cyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

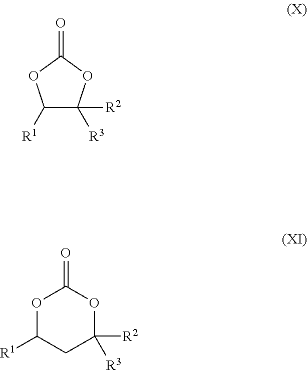

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

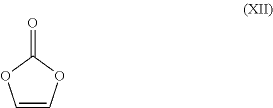

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

In one embodiment of the present invention, inventive electrochemical cells comprise one or more separators by which cathode and anode are mechanically separated from one another. Suitable separators are polymer films, especially porous polymer films, which are unreactive toward metallic lithium and toward lithium sulfides and lithium polysulfides. Particularly suitable materials for separators are polyolefins, especially porous polyethylene films and porous polypropylene films.

Polyolefin separators, especially of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

The inventive electrochemical cells can be assembled to lithium ion batteries.

Accordingly, the present invention also further provides for the use of inventive electrochemical cells as described above in lithium ion batteries.

The present invention further provides lithium ion batteries, especially lithium-sulfur batteries, comprising at least one inventive electrochemical cell as described above. Inventive electrochemical cells can be combined with one another in inventive lithium ion batteries, for example in series connection or in parallel connection. Series connection is preferred.

Inventive electrochemical cells are notable for particularly high capacities, high performances even after repeated charging and greatly retarded cell death. Inventive electrochemical cells are very suitable for use in motor vehicles, bicycles operated by electric motor, for example pedelecs, aircraft, ships or stationary energy stores. Such uses form a further part of the subject matter of the present invention.

The present invention further provides for the use of inventive electrochemical cells as described above in motor vehicles, bicycles operated by electric motor, aircraft, ships or stationary energy stores.

The use of inventive lithium ion batteries in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore also further provides for the use of inventive lithium ion batteries in devices, especially in mobile devices. Examples of mobile devices are vehicles, for example motor vehicles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The present invention further also provides for the use of a thermally treated mixture comprising starting components

(A) at least one fluorinated polymer and
(B) carbon in a polymorph comprising at least 60% sp²-hybridized carbon atoms,
or
(A) at least one fluorinated polymer and
(C) at least one sulfur-containing component,
or
(A) at least one fluorinated polymer,
(B) carbon in a polymorph comprising at least 60% sp²-hybridized carbon atoms, and
(C) at least one sulfur-containing component,
where the proportion of the sum of the proportions by weight of starting components (A) and (B), (A) and (C) or (A), (B) and (C) in the respective mixture prior to the thermal treatment, based on the total weight of the mixture prior to the thermal treatment, is 90 to 100% by weight, and where the thermal treatment of the mixture comprising starting components (A) and (B), (A) and (C) or (A), (B) and (C) is performed at a temperature of at least 115° C., for production of an electrochemical cell, more preferably for production of an electrode for an electrochemical cell, even more preferably for production of a cathode for an electrochemical cell, especially for production of a sulfur cathode for a lithium-sulfur cell.

The present invention likewise provides a thermally treated mixture comprising starting components

(A) at least one fluorinated polymer and
(C) at least one sulfur-containing component,
or
(A) at least one fluorinated polymer,
(B) carbon in a polymorph comprising at least 60% sp²-hybridized carbon atoms, and
(C) at least one sulfur-containing component,
where the proportion of the sum of the proportions by weight of starting components (A) and (C) or (A), (B) and (C) in the respective mixture prior to the thermal treatment, based on the total weight of the mixture prior to the thermal treatment, is 90 to 100% by weight, and where the thermal treatment of the mixture comprising starting components (A) and (C) or (A), (B) and (C) is performed at a temperature of at least 115° C.

With regard to the inventive use of a thermally treated mixture, and with regard to particular embodiments of the inventive thermally treated mixture, the detailed description and preferred embodiments of components (A), (B) and (C) and of the conditions for the thermal treatment correspond to the above description of these components and the conditions of the thermal treatment.

The invention is illustrated by the examples which follow but do not restrict the invention.

Figures in % relate to percent by weight, unless explicitly stated otherwise.

### I. Production of Cathodes

### I.1 Production of an Inventive Cathode K.1

### I.1.a Synthesis of Inventive Composite Material KM.1

15.0 g of sulfur, 6.0 g of Super P carbon black (from Timcal AG, 6743 Bodio, Switzerland), 6.0 g of Printex XE2 carbon black, 0.9 g of MF-C110 carbon nanofibers (from Carbon-NT&F 21, A-7000 Eisenstadt) and 2.1 g of Teflon powder were homogenized in a mortar and introduced into a 300 ml autoclave. The mixture was left under autogenous pressure without stirring at 300° C. for 12 h, in the course of which the pressure in the autoclave rose to 3.2 bar. Subsequently, the reactor was purged with nitrogen for 6 h and cooled at the same time to 20° C. 28.9 g of finely powdered material were obtained (elemental analysis: C=53.9 g/100 g, S=38.7 g/100 g, F=6.6 g/100 g).

### I.1.b Processing of Composite Material KM.1 to Give Cathode K.1

10 g of the composite material KM.1 produced in experiment 1.1.a were introduced into a laboratory glass bottle which had previously been charged with 50.0 g of a 13/6/1 mixture of water/isopropanol/1-methoxy-2-propanol, and the entire contents were stirred together. For dispersion, the suspension thus obtained was ground in a ball mill (Pulverisette from Fritsch) with the aid of stainless steel balls at 300 rpm over a period of 30 min. After the removal of the stainless steel balls, a very homogeneous ink was obtained, which had a creamy consistency. For production of cathode K.1, the ink was sprayed onto an aluminum foil (thickness: 30 μm) by means of airbrushing on a vacuum table (temperature: 75° C.). Nitrogen was used for spraying. After the spraying, the coated foil was then run through an office calendering machine at 120° C. and then dried at 40° C. and 40 mbar overnight. A sulfur loading of 1.2 mg/cm² was achieved.

### I.2 Production of a Noninventive Cathode C-K.2

15.0 g of sulfur, 6.0 g of Super P carbon black (from Timcal AG, 6743 Bodio, Switzerland), 6.0 g of Printex XE2 carbon black, 0.9 g of MF-C110 carbon nanofibers (from Carbon-NT&F 21, A-7000 Eisenstadt) and 2.1 g of Teflon powder were homogenized in a mortar. 10 g of the homogenized mixture were introduced into a laboratory glass bottle which had previously been charged with 140.0 g of a 13/6/1 mixture of water/isopropanol/1-methoxy-2-propanol, and the entire contents were stirred together. For dispersion, the suspension thus obtained was ground in a ball mill (Pulverisette from Fritsch) with the aid of stainless steel balls at 300 rpm over a period of 30 min. After the removal of the stainless steel balls, a very homogeneous ink was obtained, which had a creamy consistency. For production of the noninventive cathode C-K.2, the ink was sprayed onto an aluminum foil (thickness: 30 μm) by means of airbrushing on a vacuum table (temperature: 75° C.). Nitrogen was used for spraying. After the spraying, the coated foil was then run through an office calendering machine at 120° C. and then dried at 40° C. and 40 mbar overnight. A solids loading of 1.2 mg/cm² was achieved.

### I.3 Production of an Inventive Cathode K.3

5.59 g of sulfur, 1.76 g of Super P carbon black (from Timcal AG, 6743 Bodio, Switzerland), 1.75 g of Printex XE2 carbon black, 0.30 g of MF-C110 carbon nanofibers (from Carbon-NT&F 21, A-7000 Eisenstadt) and 0.7 g of Teflon powder were introduced into a laboratory glass bottle which had previously been charged with 160.0 g of a 13/6/1 mixture of water/isopropanol/1-methoxy-2-propanol, and the entire contents were stirred together. For dispersion, the suspension thus obtained was ground in a ball mill (Pulverisette from Fritsch) with the aid of stainless steel balls at 300 rpm over a period of 30 min. After the removal of the stainless steel balls, a very homogeneous ink was obtained, which had a creamy consistency. The ink was sprayed onto an aluminum foil (thickness: 30 μm) by means of air brushing on a vacuum table (temperature: 75° C.). Nitrogen was used for spraying. After the spraying, the coated foil was then run through an office calendering machine at 120° C. and then dried at 40° C. and 40 mbar overnight.

To produce cathode K.3, the coated aluminum foil was introduced rolled-up into a 300 ml autoclave and treated therein at 300° C. without stirring under nitrogen supply pressure 10 bar for 12 h. A pressure rise up to 21 bar was registered. After opening, the coated film appeared visually unchanged, but a small amount of condensed sulfur droplets were present on the inner wall of the autoclave. By means of elemental analysis, a sulfur loading of 1.0 mg/cm² (solids content: 40.5% sulfur) was found.

### I.4 Production of a Noninventive Cathode C-K.4

5.59 g of sulfur, 1.76 g of Super P carbon black (from Timcal AG, 6743 Bodio, Switzerland), 1.75 g of Printex XE2 carbon black, 0.30 g of MF-C110 carbon nanofibers (from Carbon-NT&F 21, A-7000 Eisenstadt) and 0.7 g of Teflon powder were introduced into a laboratory glass bottle which had previously been charged with 160.0 g of a 13/6/1 mixture of water/isopropanol/1-methoxy-2-propanol, and the entire contents were stirred together. For dispersion, the suspension thus obtained was ground in a ball mill (Pulverisette from Fritsch) with the aid of stainless steel balls at 300 rpm over a period of 30 min. After the removal of the stainless steel balls, a very homogeneous ink was obtained, which had a creamy consistency. The ink was sprayed onto an aluminum foil (thickness: 30 μm) by means of air brushing on a vacuum table (temperature: 75° C.). Nitrogen was used for spraying. After the spraying, the coated foil was then run through an office calendering machine at 120° C. and then dried at 40° C. and 40 mbar overnight. A sulfur loading of 1.2 mg/cm² was achieved. The coated aluminum foil thus obtained was designated as noninventive cathode C-K.4.

### II. Testing of Cathodes in Electrochemical Cells

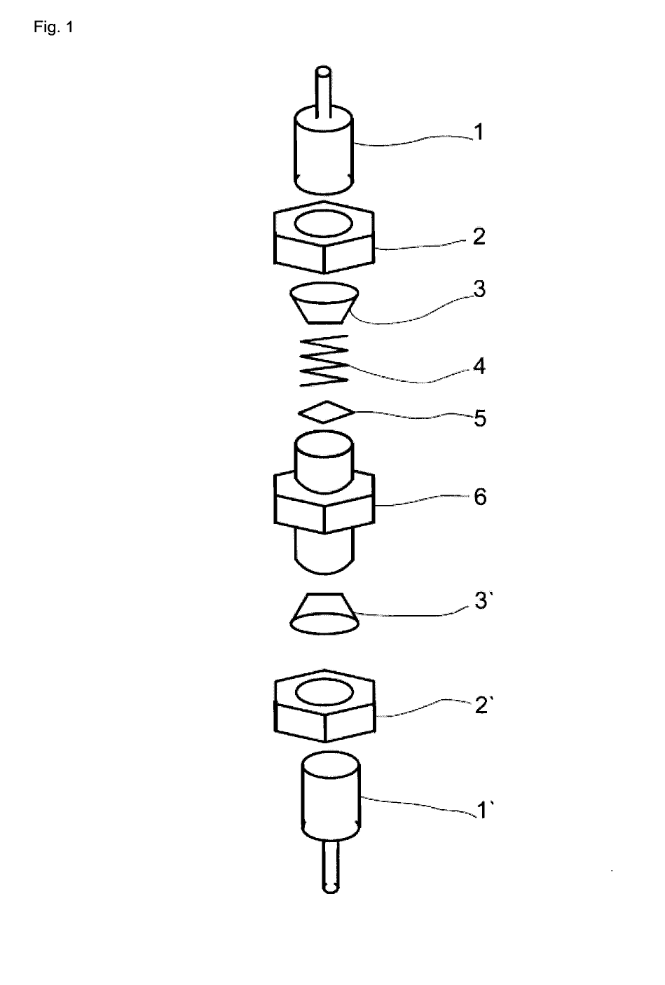

For the electrochemical characterization of the cathodes K1, C-K2, K3 and C-K4 produced in example I., the electrochemical cells were constructed according to FIG. 1. For this purpose, as well as the cathodes produced in example I., the following components were used in each case:

Anode: Li foil, thickness 50 μm,
Separator: Celgard® 2340 three-ply membrane (PP/PE/PP), thickness 38 μm
Cathode: according to example I.
Electrolyte: 1 M LiTFSI (LiN(SO₂CF₃)₂) in 1:1 mixture of dioxolane and dimethoxyethane.

The inventive cathodes K₁ and K₃ were used to produce the inventive electrochemical cells Z1 and Z3, and comparative electrodes C-K₂ and C-K₄ to construct the noninventive electrochemical comparative cells C-Z2 and C-Z4.

FIG. 1 shows the schematic structure of a dismantled electrochemical cell for testing of inventive and noninventive cathodes.

The labels in FIG. 1 mean:

1, 1′ die
2, 2′ nut
3, 3′ sealing ring—two in each case, the second, somewhat smaller sealing ring in each case is not shown here
4 spiral spring
5 output conductor made from nickel
6 housing

The charging and discharging of the electrochemical cell was conducted with a current of 5.50 mA between potentials of 1.7-2.5 V. The electrochemical results for illustration of the effect of the thermal treatment on the capacity are summarized in table 1.

TABLE 1
Test results of inventive and noninventive electrochemical cells.

| | Discharge | | Discharge |
|---|---|---|---|
| | capacity | Discharge capacity | capacity |
| | 5th cycle | 100th cycle | 150th cycle |
| Example | [mA · h/g S] | [mA · h/g S] | [mA · h/g S] |
| E. 1 comprising | 1300 | 1200 | 1020 |
| cathode K.1 | | | |
| C-E. 2 comprising | 1300 | 1080 | cell collapses |
| cathode C-K.2 | | | |
| E. 3 comprising | 1240 | 1080 | 971 |
| cathode K.3 | | | |
| C-E. 4 comprising | 1280 | 1050 | cell collapses |
| cathode C-K.4 | | | |

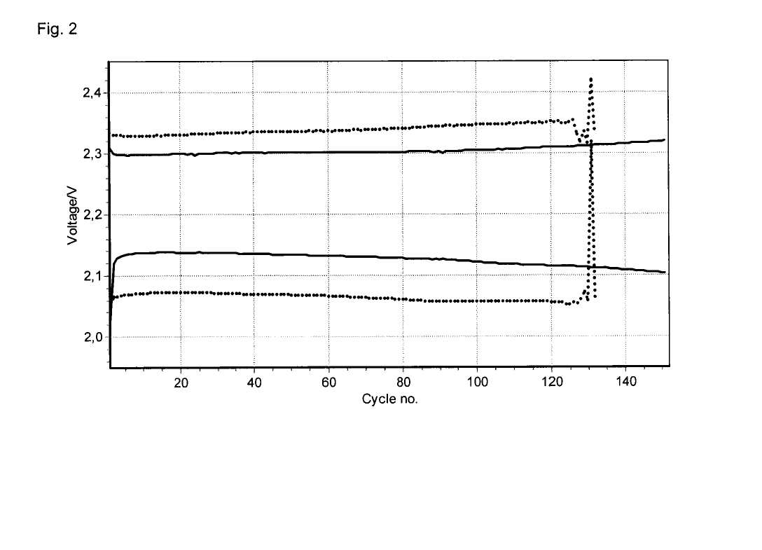

FIG. 2 shows the average charge and discharge voltages of the electrochemical cells E1 (continuous lines) and C-E.2. The number of cycles is plotted on the x axis and the voltage in volts on the y axis.

The inventive lithium-sulfur cell Z.1 has a distinct improvement in charge and discharge voltages compared to comparative cell C-Z.2. Z.1 exhibits a low voltage in the charging operation (approx. 2.3 V) and a higher voltage in the discharging operation (approx. 2.13 V) than C-Z.2.

1. A composite material
obtained by thermally treating a mixture in one stage, wherein the mixture comprises:
(A) a fluorinated polymer and
(B) carbon in a polymorph comprising at least 60% sp²-hybridized carbon atoms;
or
(A) a fluorinated polymer and
(C) a sulfur-comprising component;
or
(A) a fluorinated polymer,
(B) carbon in a polymorph comprising at least 60% sp²-hybridized carbon atoms, and
(C) a sulfur-comprising component,
wherein the proportion of the sum of the proportions by weight of starting components (A) and (B), (A) and (C), or (A), (B), and (C) in the respective mixture prior to the thermal treatment, based on the total weight of the mixture prior to the thermal treatment, is 90 to 100% by weight, and wherein the thermal treatment of the mixture comprising starting components (A) and (B), (A) and (C), or (A), (B), and (C) is performed at a temperature of at least 115° C.

2. The composite material of claim 1 wherein the fluorinated polymer is polytetrafluoroethylene.

3. The composite material of claim 1, wherein carbon (B) is carbon black.

4. The composite material any of claim 1, wherein the sulfur-comprising component is elemental sulfur.

5. The composite material of claim 1, wherein the proportion by weight of starting component (A) in the respective mixture prior to the thermal treatment, based on the total weight of the mixture prior to the thermal treatment is 4 to 11% by weight.

6. The composite material of claim 1, wherein, prior to the thermal treatment of the mixture, starting components (A) and (B), (A) and (C), or (A), (B), and (C) are homogeneously distributed in the mixture.

7. The composite material of claim 1, wherein the thermal treatment of the mixture comprising starting components (A) and (B), (A) and (C), or (A), (B), and (C) is performed at a temperature in the range from 250 to 380° C.

8. The composite material of claim 1, wherein, prior to the thermal treatment of the mixture, the mixture of starting components (A) and (B), (A) and (C), or (A), (B) and (C) has a hydrogen content of less than 0.5% by weight, determined by means of elemental analysis.

9. The composite material of claim 1, wherein the sum of the contents of the elements carbon, sulphur, and fluorine in the composite material, determined by means of elemental analysis, is at least 95% by weight.

10. A process for producing a composite material, the process comprising thermally treating, at a temperature of at least 115° C., a mixture comprising:
(A) a fluorinated polymer, and
(B) carbon in a polymorph comprising at least 60% sp²-hybridized carbon atoms;
or
(A) a fluorinated polymer, and
(C) a sulfur-comprising component;
or
(A) a fluorinated polymer,
(B) carbon in a polymorph comprising at least 60% sp²-hybridized carbon atoms, and
(C) a sulfur-comprising component,
wherein the proportion of the sum of the proportions by weight of starting components (A) and (B), (A) and (C), or (A), (B), and (C) in the respective mixture prior to the thermal treatment, based on the total weight of the mixture prior to the thermal treatment, is 90 to 100% by weight.

11. A process for producing the composite material of claim 1, the process comprising thermally treating, at a temperature of at least 115° C., a mixture comprising
(A) a fluorinated polymer, and
(B) carbon in a polymorph comprising at least 60% sp²-hybridized carbon atoms;
or
(A) a fluorinated polymer and
(C) a sulfur-comprising component;
or
(A) a fluorinated polymer,
(B) carbon in a polymorph comprising at least 60% sp²-hybridized carbon atoms, and
(C) a sulfur-comprising component,
wherein the proportion of the sum of the proportions by weight of starting components (A) and (B), (A) and (C), or (A), (B), and (C) in the respective mixture prior to the thermal treatment, based on the total weight of the mixture prior to the thermal treatment, is 90 to 100% by weight.

12. The process of claim 10, wherein the thermal treatment of the mixture comprising starting components (A) and (B), (A) and (C), or (A), (B) and (C) takes place at a temperature in the range from 250 to 380° C.

13. A cathode material, comprising the composite material of claim 1.

14. An electrochemical cell, comprising:
a cathode comprising the cathode material of claim 13.

15. The electrochemical cell of claim 14, further comprising an electrode comprising metallic lithium.

16. The electrochemical cell of claim 14, comprising a liquid electrolyte comprising a lithium-comprising conductive salt.

17. The electrochemical cell of claim 14, comprising at least one nonaqueous solvent selected from the group consisting of a polymer, a cyclic or noncyclic ether, a noncyclic or cyclic acetal, and a cyclic or noncyclic carbonate.

18. (canceled)

19. A lithium ion battery, comprising the electrochemical cell of claim 14.

20-21. (canceled)

22. A thermally treated mixture comprising
(A) a fluorinated polymer and
(C) a sulfur-comprising component;
or
(A) a fluorinated polymer,
(B) carbon in a polymorph comprising at least 60% sp²-hybridized carbon atoms, and
(C) a sulfur-comprising component,
wherein the proportion of the sum of the proportions by weight of starting components (A) and (C) or (A), (B) and (C) in the respective mixture prior to the thermal treatment, based on the total weight of the mixture prior to the thermal treatment, is 90 to 100% by weight, and wherein the thermal treatment of the mixture comprising starting components (A) and (C) or (A), (B), and (C) is performed at a temperature of at least 115° C.
